(19) United States
(12) Patent Application Publication
(10) Pub. No.: US 2008/0195008 A1
(43) Pub. Date: Aug. 14, 2008

(54) Therapeudic massage sock

(76) Inventor: Reginald J. Davis, Cockeysville, MD (US)

Correspondence Address: Ober, Kaler, Grimes & Shriver;Attorneys at Law, 120 East Baltimore Street, Baltimore, MD, 21202-1643, US

(21) Appl. No.: 12/011,630

(22) Filed: Jan. 28, 2008

Related U.S. Application Data
(60) Provisional application No. 60/897,772, filed on Jan. 26, 2007.

(51) Int. Cl. A61H 7/00

(52) U.S. Cl. 601/151

(57) ABSTRACT

A pneumatic/hydraulic massage sock comprised of a web of hydraulic/pneumatic tubes connected to a pump in the sole of the sock. The over-the-calf web comprises a spiral web of interconnected flexible tubes. The web of tubes is encased in a fabric shell that generally conforms to the foot and calf and is worn like a sock. Mere walking produces a cumulative pump force to inflate/constrict the upper web in cyclic patterns to promote an effective kneading-pattern massage. The massage sock provides effective relief for individuals with circulatory disabilities, diabetes, arthritis, etc. They would offer mild, non-constricting variable pattern-compression and yet are non-intrusive and maintain a low-profile.

### CROSS-REFERENCE TO RELATED APPLICATIONS

The present application derives priority from U.S. provisional application No. 60/897,772 filed 26 Jan. 2007.

### BACKGROUND OF THE INVENTION

1. Field of the Invention

The present invention relates to therapeutic footwear and, more particularly, to a self-compressive massage sock useful for patients susceptible to foot problems resulting from diabetes or other circulatory foot conditions.

2. Description of the Background

Sitting stationery for long periods of time leads to an impaired venous return in the lower limbs that engenders local gatherings of blood. This causes swelling and discomfort around the ankles. Moreover, the effects of long term sitting can be serious as stasis can lead to the formation of blood clots, pulmonary embolisms, etc. Certain segments of the population are more prone to these symptoms, including the elderly and those with diabetes.

Diabetic neuropathies can be classified as peripheral, autonomic, proximal, and focal, each of which affects different parts of the body in different ways. Peripheral neuropathy (or distal symmetric neuropathy) tends to affect the arms and legs with circulation problems. Symptoms include either pain or loss of feeling in the toes, feet, legs, hands, and arms. Blisters and sores may appear on numb areas of the foot, and the loss of sensation in the feet means that such sores or injuries may not be noticed and may become ulcerated or infected. If foot injuries are not treated promptly, the infection may spread to the bone. Indeed, cardiovascular complications resulting from diabetes are the leading cause of lower-limb amputations in diabetics.

It is well-known that diminished circulation in the extremities and particularly the feet can be treated by massage therapy. Consequently, a variety of massaging socks, stockings, shoes and foot pads currently exist. However, these rely primarily on friction to impart the massage, which does little for circulation.

Compression is a more appropriate therapy for those seeking to increase circulation. Compressive devices seeking to prevent or reduce thrombosis have been proposed. For example, an inflatable compression garment is disclosed in GB-A-2271060, and an ambulatory pneumatic compression device is disclosed in GB-A-2263405. Blood circulation in a limb is stimulated by a periodically inflatable sheet which is wrapped around a patient's foot. Unfortunately, this is cumbersome to apply and requires an external pressure source. GB-A-2263405 discloses an orthopeadic shoe connected to cells wrapped around the calf and ankle of a user and operable to exert a pumping effect to the cells as the user walks. When the patient walks air is moved from air cells in the heel to cells in the ankle and calf. This sequentially increases the pressure exerted on the patient's ankle and calf, promoting peripheral circulation to treat leg ulcers. While the concept is valid the implementation lacks effectiveness because it relies on constriction which occurs only at the heel strike and uniformly around two collar-like pads wrapped around the ankle. The effect is somewhat less than a massage which should be applied with a kneading, non-constricting variable pattern-compression motion. Moreover, the user is constrained to wearing just one pair of shoes.

Similarly, U.S. Pat. No. 6,589,194 to Calderon et al. (C-Boot Ltd) issued Jul. 8, 2003 shows a self-powered compression device for promoting circulation and therapeutic compression. The device is self-powered, employing a plurality of inflatable sleeves arranged sequentially for applying compression to a body or limb, and a pump, a piping system and a bandage or boot to enclose the sleeves and pump in their its entirety. The device uses self-generated pressure from walking in promoting circulation for treatment of lymphatic and traumatic edemas, venous disorders, limb ulcers, varicose veins, muscle fatigue, sports medicine, cellulite treatment, diabetic feet, and simple feet massage for recreation or cosmetic enhancements. This device is still rather cumbersome and relies on pure constriction, not a non-constricting variable pattern-compression motion.

U.S. Pat. No. 6,409,691 to Dakin et al. (Daos Limited) issued Jun. 25, 2002 shows a liquid brace with a number of flexible compression bags pressurized by a pump, which may be driven by muscle contracting or weight-bearing activities. The pump may provide a dynamic, oscillatory pressure. The bags are separated by valves allowing the liquid to flow in a controlled manner through the bags.

There are also a variety of inflatable orthotics, such as inner soles with inflated cushions at either the toe and heel areas. The cushions circulate air and ventilate the shoe or boot during walking activities. See, for instance, U.S. Pat. Nos. 3,180,039, 2,716,293 and 1,213,941. However, the inflating pads are for support and do nothing for circulation. More recently, Nike™ has introduced a sole with integral self-inflating pads. The pads are inflated by an on-board finger pump. Similarly, U.S. Pat. No. 5,846,063 to Lakic discloses an air pump and relief valve assembly that can be sealed to a flat sheet of plastic and embedded in the sole.

It would be greatly advantageous to provide a therapeutic massage sock operable by an embedded pump to provide a self-compressive non-constricting and yet deep-kneading patterned massage action, which can be worn with virtually any conventional pair of shoes, to benefit patients susceptible to foot problems resulting from diabetes or other circulatory foot conditions.

### SUMMARY OF THE INVENTION

It is therefore an object of the present invention to provide a therapeutic massage sock with embedded full-length heel-to-ball-to-toe foot pump and a spirical web of pneumatic or hydraulic tubes to provide a self-compressive non-constricting and yet deep-kneading patterned massage action.

It is another object to provide the above-described embedded sole pump and spirical web of tubes in a fabric shell that looks and feels like a conventional sock and can be worn with virtually any conventional pair of shoes, benefitting patients susceptible to foot problems resulting from diabetes or other circulatory foot conditions.

In accordance with the foregoing objects, the present invention is a pneumatic massage sock comprised of a web of hydraulic/pneumatic tubes connected to a full-length pump in the sole of the sock. The over-the-calf web comprises a spiral (or spiderweb mesh) of interconnected flexible tubes. The web of tubes generally conforms to the foot and calf and is embedded in a fabric shell so that it can be worn like any conventional sock. Mere walking produces a heel-to-ball-to-toe pumping force that inflates/constricts the upper web in a cyclic pattern to promote an effective deep-kneading massage. The massage sock provides effective relief for individuals with circulatory disabilities, diabetes, arthritis, etc. They would offer mild, non-constricting variable pattern-compression and yet are non-intrusive and maintain a low-profile.

### BRIEF DESCRIPTION OF THE DRAWINGS

Other objects, features, and advantages of the present invention will become more apparent from the following detailed description of the preferred embodiment and certain modifications thereof when taken together with the accompanying drawings in which:

FIG. 1 is a perspective view of the therapeutic massage sock 2 according one embodiment of the present invention.

FIG. 2 is an exemplary embodiment of the heel pump 20.

FIG. 3 illustrates an exemplary flow valve at the intersection of two tubes 10.

FIG. 4 is a perspective view of another embodiment of a therapeutic massage sock 120.

### DETAILED DESCRIPTION OF THE PREFERRED EMBODIMENTS

The present invention is a therapeutic massage sock generally comprising a web of hydraulic or pneumatic tubes encased in a fabric shell for wearing like a sock, the tubes being inflatable by an embedded pump in the sole of the sock which provide a self-compressive non-constricting and yet deep-kneading patterned massage action. The massage sock looks and feels substantially like a normal sock and can be worn with virtually any conventional pair of shoes, to benefit patients susceptible to foot problems resulting from diabetes or other circulatory foot conditions.

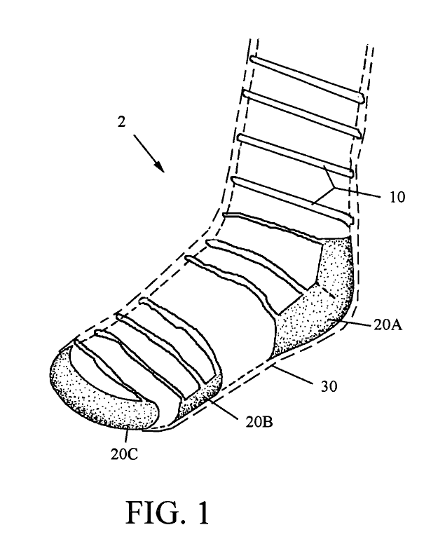

FIG. 1 is a perspective view of the therapeutic massage sock 2 according one embodiment of the present invention.

The therapeutic massage sock 2 generally comprises a full-sole pump 20 including separate heel 20A, ball 20B and toe 20C regions for progressively circulating air or fluid throughout an interconnected spiral web of hydraulic/pneumatic tubes 10, all in fluid connection to the pump 20. The web 10 of tubes as well as the full-sole pump 20 are encased in a fabric shell 30 to give an inner feel and outer appearance similar to a conventional sock. The fabric shell 30 can be cotton or synthetic fabric that likewise conforms to the foot and calf. Thus, the massage sock 2 can be worn over-the-calf in most any natural day-to-day situation. The web of tubes 10 generally conforms to the foot and calf and runs spirically up the foot/leg so that fluid pumped there through induces a kneading sensation moving up the leg. If necessary, the tubes 10 may be interconnected at valves 12, each of which may be a junction formed with calibrated orifices for controlling the flow of fluid (air or liquid) therein.

The individual tubes 10 may be interconnected in various other patterns (other than spirical) such as a lattice-work mesh, or spider-web mesh running upward along the foot and leg. Presently, the tubes 10 emanate from one of the separate heel 20A, ball 20B or toe 20C regions of pump 20 and run substantially spirically upward along the foot and leg in a spaced relation. However, as mentioned above one skilled in the art will readily understand that a variety of suitable patterns may be adapted depending on the desired massage effect.

In use, mere walking or running produces a cumulative heel-to-ball-to-toe pump force as the separate heel 20A, ball 20B and toe 20C regions of pump 20 strike down, and this inflates/constricts the upper web of tubes 10 in cyclic patterns to promote an effective kneading-pattern massage. The rate and direction of spread and hence the massage pattern may be governed by the particular pattern of tubes 10 chosen as well as flow valves 12 used for interconnecting the tubes. In contrast to a uniform purely constrictive massage, the flow-control exerted in the upper web of tubes 10 forms cyclic patterns of fluid flow progressing up then down the leg to promote an effective kneading-type massage, and more effective relief for individuals with circulatory disabilities, diabetes, arthritis, etc.

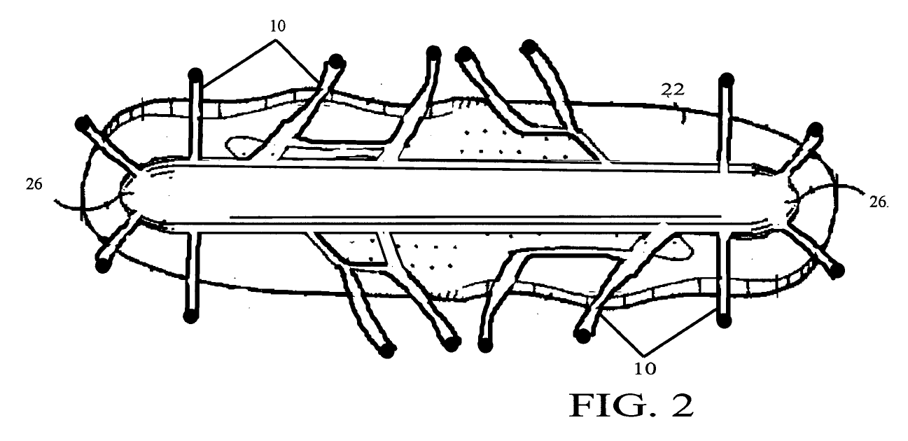

FIG. 2 is an exemplary embodiment of the heel pump 20 which is embedded in the fabric layer 30 and may additionally, if desired, be carried on an orthotic foam footpad layer 22. Footpad layer 22 is preferably made from a firm, compressible, lightweight, and moldable material such as ethyl vinyl acetate (EVA). Extending from the heel, to the ball and toe of a foot is an elongate concave bubble 26 molded into footpad layer 22. In a hydraulic embodiment the bubble 26 may be filed with a fluid. In a pneumatic embodiment the bubble 26 may be filled with air or may have perforations adapted to draw air in and expel it. A plurality of channels extend from the bubble 26 and these are in fluid communication with the tubes 10 (FIG. 1). When the patient walks air/fluid is pumped out of the bubble 26 and is moved into the tubes 10 for patterned distribution to the ankle and calf, thereby sequentially increasing the pressure exerted on the patient's ankle and calf.

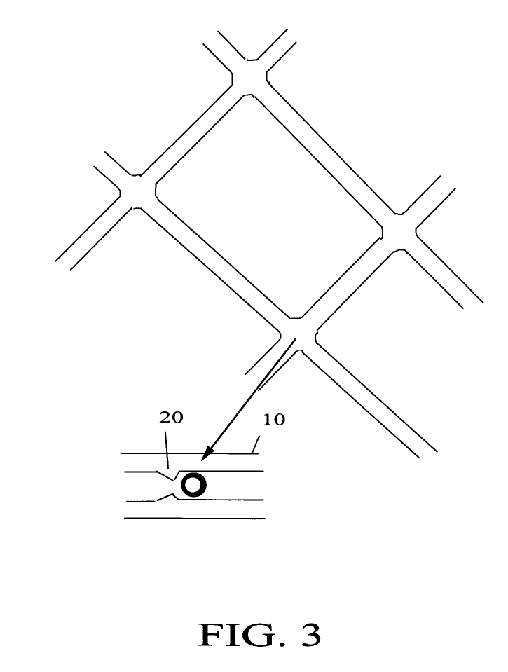

When it is desirable to control the fluid flow throughout the web of tubes 10 by the use of valves, FIG. 3 illustrates an exemplary flow valve 12 at the intersection of two tubes 10. Each flow valve 12 may be a four-way junction formed with calibrated orifices for controlling the flow of fluid (air or liquid) therein. The tubes 10 may be formed of a suitable resilient material such as silicon rubber, and the entire web of tubes 10 may be integrally molded along with flow valves 12. The purpose of the valves 12 is to retard the flow of air/fluid as it moves upward throughout the entire web of tubes 10. Thus, the tubes 10 will initially inflate toward the bottom of the foot (proximate pump 20) and progressively upward as the air/fluid makes its way through the valves 12 and into the upper tubes 10. The web of tubes 10 ensures a steady radial-spiral flow of air/liquid around the foot as well. This calibrated flow results in a patterned distribution to the ankle, then to the calf, and upward, thereby sequentially increasing the pressure exerted upward along the leg. This cyclic pattern of fluid flow promotes a more effective kneading-type massage, and more effective relief for individuals with circulatory disabilities, diabetes, arthritis, etc.

One skilled in the art will readily understand that the purpose of the valves 20 may be assumed by constricting internal cross-section of the tubes 10 at their junctions. Either way, the foregoing massage socks 2 provide an excellent self-compressive, non-constricting and yet deep-kneading patterned massage action upward along the foot and leg for more effective relief from tired feet, and more comprehensive treatment of foot problems resulting from diabetes or other circulatory foot conditions. Moreover, the massage socks 2 provide a very low unobtrusive profile and can be worn with virtually any conventional pair of shoes.

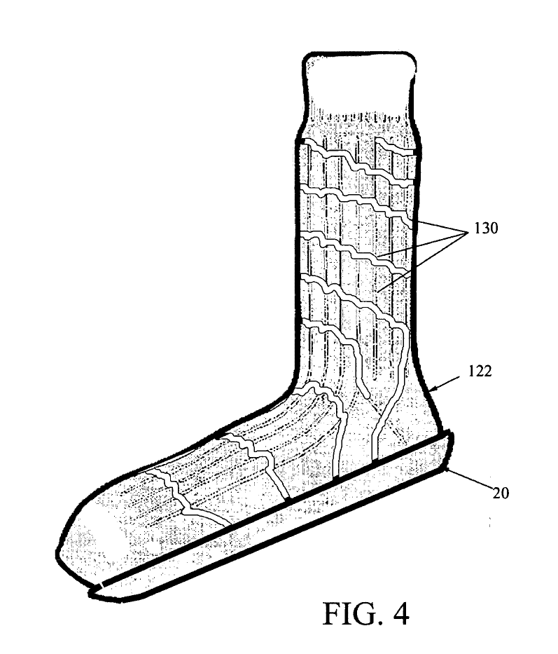

FIG. 4 is a perspective view of another embodiment of a therapeutic massage sock 120 comprising the same full-sole pump 20 of FIG. 2. In this embodiment the interconnected spiral web of hydraulic/pneumatic tubes 10 of FIGS. 1-3 is replaced by a unitary molded shell 122 having an interconnected web of hydraulic/pneumatic channels 130 molded interiorly inside the shell 122, all in fluid connection to the pump 20. The web 130 of channels is fully encased within the molded shell 122, which may be Silicon rubber or other suitable material. IN addition, the molded shell 122 as well as the full-sole pump 20 may be encased together in a fabric shell (as described above) to give an inner feel and outer appearance similar to a conventional sock. The fabric shell can be cotton or synthetic fabric that likewise conforms to the foot and calf. Thus, the massage sock 120 can be worn over-the-calf in most any natural day-to-day situation. The shell 122 generally conforms to the foot and calf, and the channels 130 molded interiorly inside the shell 122 may again run spirically up the foot/leg so that fluid pumped there through induces a kneading sensation moving up the leg. If necessary, the channels 130 may be interconnected at valves (as valves 12 above), each of which may be a junction formed with calibrated orifices for controlling the flow of fluid (air or liquid) therein. The individual channels 130 may be interconnected in various other patterns (other than spirical) such as a lattice-work mesh, or spider-web mesh running upward along the foot and leg. Presently, the channels 130 emanate from pump 20 and run substantially spirically upward along the foot and leg in a spaced relation. However, as mentioned above one skilled in the art will readily understand that a variety of suitable patterns may be adapted depending on the desired massage effect.

The use of the massage sock 120 is substantially the same, mere walking or running produces a cumulative heel-to-ball-to-toe pump force as the separate heel 20A, ball 20B and toe 20C regions of pump 20 strike down, and this inflates/constricts the upper web of channels 130 in cyclic patterns to promote an effective kneading-pattern massage. The rate and direction of spread and hence the massage pattern may be governed by the particular pattern of channels 130 within the shell 122, as well flow valves 12 as necessary. In contrast to a uniform purely constrictive massage, the flow-control exerted in the upper web of channels 130 forms cyclic patterns of fluid flow progressing up then down the leg to promote an effective kneading-type massage, and more effective relief for individuals with circulatory disabilities, diabetes, arthritis, etc.

Having now fully set forth the preferred embodiments and certain modifications of the concept underlying the present invention, various other embodiments as well as certain variations and modifications thereto may obviously occur to those skilled in the art upon becoming familiar with the underlying concept. It is to be understood, therefore, that the invention may be practiced otherwise than as specifically set forth herein.

I claim:

1. A therapeutic massage sock, comprising:
a full-length sole pump for circulating air or fluid at each heel and forefoot strike;
a web of tubes joined together at said sole pump to form an interconnected web generally conforming to a foot and calf, said tubes being in fluid communication with said sole pump;
whereby each foot strike initiates a self-compressive, non-constricting pattern of compression by progressive inflation of said tubes in a kneading patterned massage action spreading progressively upward along the foot and leg.

2. A therapeutic massage sock, comprising:
a sole including a pump for circulating air or fluid at each heel and forefoot strike;
a shell integrally joined to said sole, said shell comprising an interior web of channels in communication with said sole pump;
whereby each foot strike initiates a self-compressive, non-constricting pattern of compression by progressive inflation of said tubes in a kneading patterned massage action spreading progressively upward along the foot and leg.
